(19) United States
(12) Patent Application Publication
(10) Pub. No.: US 2007/0269762 A1
(43) Pub. Date: Nov. 22, 2007

(54) Method of adhering ceramic particles on an orthodontic bracket

(76) Inventors: Peter Ho Kim, Los Angeles, CA (US); Jeng Su Choi, Kyungki-Do (KR)

Correspondence Address: KIM, Peter Ho, 123 South Figueora St. # 1944, Los Angeles, CA, 90012, US

(21) Appl. No.: 11/438,151

(22) Filed: May 22, 2006

(51) Int. Cl. A61C 3/00

(52) U.S. Cl. 433/9

(57) ABSTRACT

A method of adhering composite of ceramic particles to a surface of an orthodontic bracket that has a base portion for attachment to a tooth is provided. The particles are comprised of products of reaction of molten aluminum hydroxide, hydroxyapatate (calcium phosphate hydroxide), and alumina in an inert atmosphere. Average particle size of aluminum powder and hydroxyapatate powder is 30 micrometer. Mixture of nanometer and micrometer alumina is used. Aluminum hydroxide powder and other materials which are provided in dry powder form is dispersed in a high viscosity mineral oil. Molten aluminum hydroxide at 300° C. holds the other particles in place and reacts with hydroxyapatate to produce complex of aluminum phosphate and calcium hydroxide. Programmed heat treatment produce an orthodontic bracket having an opaque base portion for attachment to a tooth that shows bond strength of 180 kg/cm² though the maximum temperature of heat treatment is lower than 1,000° C.

### FIELD OF THE INVENTION

The present invention relates to a method of adhering a monolayer of ceramic particles on a tooth contacting surface of an orthodontic bracket at temperature lower than 1,000° C. without using organic bond.

### BACKGROUND OF THE INVENTION

Orthodontic brackets have been made of metals and many improvements have been made to metal brackets and the adhesive used to bond the metal bracket to the teeth. As a result, the bonding of typical prior art metal brackets to the teeth has reached generally acceptable values. Meanwhile, more wearers concern about aesthetic view more than the mechanical strength of the bracket. Therefore, many brackets of theses days are made of a ceramic material for aesthetic value. However, it is much more difficult to secure those ceramic brackets directly to the teeth. Many improvement has been achieved by providing a base portion for attachment to a tooth with a substantially monolayer of substantially uniform sized zircornia particles of 5 to 200 microns in diameter. But, the method needs very high temperature of 1,600° C., which is close to the melting point of the alumina. And maintaining such high temperature costs lot of electricity. It is the purpose of the current application to provide method for producing an orthodontic bracket at lower temperature without sacrificing bonding strength and aesthetic qualities of the bracket.

### DESCRIPTION OF THE PRIOR ARTS

U.S. Pat. No. 4,681,538 to De Luca, et al. illustrates a method of enhancing adhesive force of a crystalline alumina to a tooth by coating the surface of the alumina that is to be in contact with the adhesive, with a very thin coating of a siliceous material such as sputter coated silica. This method is very expensive because of the sputtering process.

U.S. Pat. Nos. 5,071,344 and 5,197,873 to Wong, et al. illustrates an orthodontic bracket having a base portion for attachment to a tooth. The base portion is provided with a substantially monolayer of substantially uniform sized particles. The particles may have a size in the range of 5 to 200 micron. The bracket is placed in a furnace and the furnace is heated to approximately 600° C., at a rate of 15° C./min, to burn off organic binder used to hold the particles. Hold the furnace at 600° C. for 30 to 60 minutes. Thereafter, the orthodontic bracket is heated to a second higher temperature to approximately 1600° C. The orthodontic bracket is maintained at this temperature for about 30 to 60 minutes.

Though the maximum temperature is 400° C. lower than the melting temperature of the alumina, it is still dangerous to operate. If a high temperature shooting happens in the furnace the silica will melt down. U.S. Pat. No. 5,219,283 to Farzin-Nia, et al. illustrates an orthodontic bracket having a base portion for attachment to a tooth. The base portion is etched with a solution containing three parts 48% hydrofluoric acid and one part 85% H₃ PO₄. The solution is applied to the surface for 30-60 seconds at room temperature. After that the base is rinsed with de-ionized water for approximately 1 minute followed by drying at about 100° C. for about 1 hour. A substantially monolayer of substantially uniform size particles is provided on the etched base. The particles are secured to the bonding base through the use of an adhesive. In another aspect, there is provided a method of making an orthodontic bracket having a bonding base for attachment to the surface of a tooth, comprising the steps of: (a) applying a curable adhesive layer to the bonding base; (b) applying a substantially monolayer of particles of substantially uniform size to the bonding base; and (c) curing the adhesive so as to bond the particles to the bonding surface. In yet another aspect there is provided an orthodontic bracket having a bonding base for attachment to the surface of a tooth. The bonding base having means for minimizing removal of enamel from the tooth during removal of the bonded bracket from the tooth. No bond strength is illustrated because this method is similar to the other adhesive applying method and the bonding strength is not concerned.

None of the prior art illustrates a safe and economical process for producing an orthodontic bracket at lower temperature without sacrificing bonding strength and aesthetic qualities of the bracket as shown in the current application.

### SUMMARY OF THE INVENTION

Aesthetic brackets have recently become popular. Many brackets are made of a ceramic material for aesthetic value. However, the methods of producing a ceramic aesthetic bracket needs very high temperature of 1,600° C., which is close to the melting point of the alumina. It is the purpose of the current application to provide method for producing an orthodontic bracket at lower temperature without sacrificing bonding strength and aesthetic qualities of the bracket. A method of producing an orthodontic bracket having a base portion for attachment to a tooth is provided. The base portion is provided with a thin layer of composite particles. The particles are comprised of products of reaction of aluminum hydroxide, calcium phosphate hydroxide, and alumina in an inert atmosphere. Average particle size of aluminum hydroxide powder and calcium phosphate hydroxide is 30 micrometer. Mixture of nanometer and micrometer alumina is used. Aluminum hydroxide powder from atomizer and other materials in a dry powder form are dispersed in a mineral oil. Molten aluminum hydroxide at 300° C. holds the other particles in place and reacts with calcium phosphate hydroxide to produce aluminum phosphate hydroxide and calcium hydroxide. Programmed heat treatment produce an orthodontic bracket having an opaque base portion for attachment to a tooth that shows bond strength of 180 kg/cm² though the maximum temperature of heat treatment is lower than 1,000° C.

### BRIEF DESCRIPTION OF THE DRAWINGS

FIG. 1 is a top perspective view of an orthodontic bracket made of a prior art.

FIG. 2 is a bottom perspective view of the orthodontic bracket of FIG. 1 of the prior art.

FIG. 3 is an enlarged partial front elevation view of the bonding base of a bracket before the bracket is exposed to a heat treatment according to the current application.

FIG. 4 is a heat treatment curve of the orthodontic bracket of the current application.

FIG. 5 is an enlarged perspective view of the bonding vase of the bracket when the aluminum is melt at the temperature of 660° C. according to the current application.

### DETAILED DESCRIPTION OF THE PREFERRED EMBODIMENT

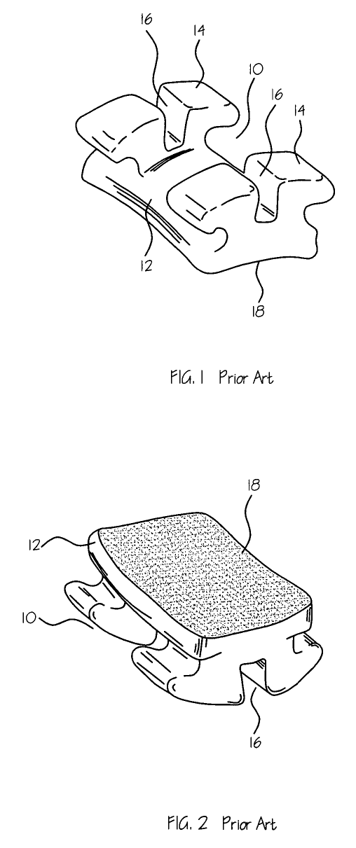

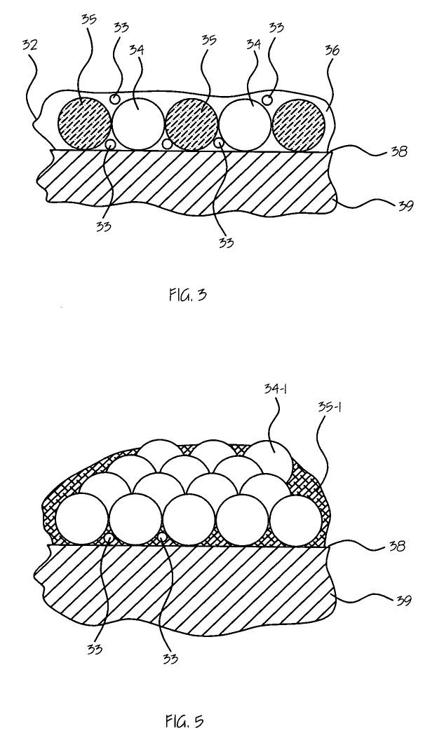

Referring to FIGS. 1 to 2, there is illustrated orthodontic bracket (10) for attachment directly to a tooth of a patient made according to prior art. The orthodontic bracket comprises a base portion (12) and a pair of tie wings (14) which extend from the base portion (12). Tie wings (14) are each provided with an elongated slot (16) for receiving an orthodontic arch wire. Preferably the orthodontic bracket (10) is made of a single crystal alumina material. The base (12) has a tooth contact surface (18) for placement against the surface of a tooth of a patient. Surface (18) is provided with a substantially monolayer (19) of individual particles (20) of substantially uniform size secured thereto having a size in the range of 5 microns to 200 microns.

FIG. 3 is an enlarged partial front elevation view of the bonding base (31) of a bracket before the bracket is exposed to a heat treatment according to the current application. The particles forming monolayer (32) are comprised of alumina powder (33), hydroxyapatate powder (34) and aluminum hydroxide powder (35). Average particle size of aluminum hydroxide powder (35) and calcium phosphate hydroxide powder (34) is 30 micrometer.

Experiment

1. Preparation of the Precursor for Monolayer Comprising Material;

All the materials are stored in a Glove-Box under nitrogen atmosphere. Moisture level in the glove box is controlled under 1 ppm and oxygen level is controlled under 10 ppm. Mixture of nanometer and micrometer alumina powder (33) is used. Aluminum hydroxide powder (35) from atomizer is dispersed in a mineral oil (36) in the Glove-Box. Viscosity of the mineral oil (36) is 150 centipoises at 25° C.

25 volume % of aluminum hydroxide powder (35) in the mineral oil (36) is prepared at room temperature in the Glove-Box and bottled in a 1 liter glass bottle. Hydroxyapatate powder (34) and alumina powder (33), volume of each is equal to the volume of the aluminu powder (35), are added to the glass bottle containing the aluminum hydroxide powder (35) and the mineral oil (36). The bottle containing the mineral oil (36) and the powders (33), (34), (35) are rolled on a roll mixer for overnight.

Thin layer of the slurry, wherein powders (33), (34), (35) are dispersed in the mineral oil (36), is pasted on a tooth contacting surface (38) of a bracket (39) with a stainless steel needle of gauge 20, 0.9 mm thickness, because the size of the tooth contacting surface (38) of a brackets (39) available from market is smaller than 5 mm (length) by 5 mm (width). Due to high viscosity of the mineral (36) oil used the particles (33), (34) and (35) hold in position. 10 samples of slurry pasted brackets (39) are prepared at a time and put into a sealed plastic container, which can be easily found from a market, and carried out of the Glove-Box. Meanwhile, an electric furnace is heated at 120° C. and purged with nitrogen. Take out the 10 samples from the sealed plastic container and put into the electric furnace.

The particles (33), (34), and (35) are placed in a position surrounded by the high viscosity mineral oil (36) as shown in FIG. 3. Aluminum hydroxide powder (35) and hydroxyapatate powder (34) has same average particle size. Meanwhile, alumina powder (33) is a 10/90 mixture of micrometer powder and nanometer powder. Nanometer powder is applied to facilitate zone melting of the alumina.

2. Heat Treatment;

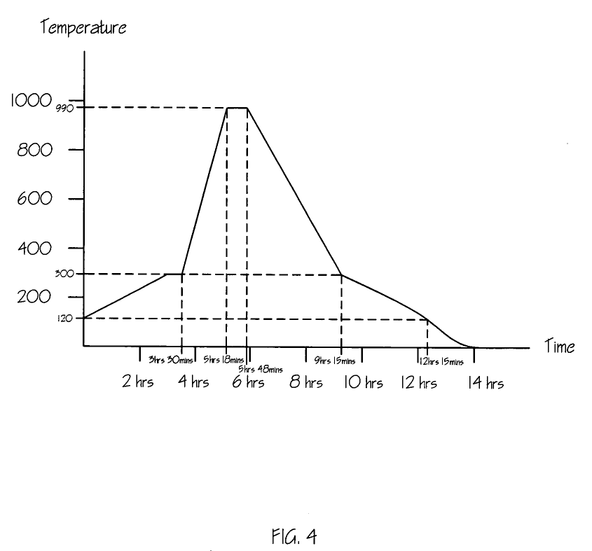

FIG. 4 is a heat treatment curve of the orthodontic bracket (39) of the current application. Temperature in the FIG. 4 is a reading from thermometer installed inside of the electric furnace. Therefore, the initial temperature is 120° C. Temperature is increased at a rate of 1° C./min. After 3 hours from the beginning temperature until it reaches 300° C. and stayed at this temperature for 30 minutes. Mineral oil is evaporated before this temperature. At this temperature, the aluminum hydroxyl powder (35) melts and starts to react with the hydroxyapatite powder (34) to produce aluminum substituted (34-1) compound and calcium hydroxide as a by product. Meanwhile, excess molten aluminum hydroxide (35-1), that does not involved in the substitution reaction, surrounds the other particles (33) and (34) to stay on the tooth contacting surface (38) of a bracket (39) as shown in the FIG. 5.

After 30 minutes stay at the melting temperature of aluminum, temperature of the electric furnace is increased to 990° C. with a heating rate of 5° C./min. It is found that the reaction of molten aluminum and hydroxyapatite at 990° C. is extremely exothermic. Therefore, the local temperature among the particles (34), (35), and (36) is much higher than the reading temperature of the furnace. If the furnace temperature is increased over 1,200° C., the final product showed destroyed mono layer on the tooth contacting surface (38). Maximum temperature lower than 800° C. produces a mono layer having poor bond strength.

After stay at 990° C. for 30 minutes, the furnace temperature lowered to 300° C. within 4 hours with a cooling rate of 3° C./min. Then cooled to room temperature within another 3 hours. Cooling rate is 3.6° C./min.

3. Bond Strength of the Bracket;

Bond strength of the bracket (39) treated with heat as shown in FIG. 4 shows average value of 187 Kg/cm². Table 1. shows the bond strength of the bracket (39) produced in accordance of the current application and other products on market.

TABLE 1

| Sample | Current Invention | Inspire Ice* | Clarity** |
|---|---|---|---|
| Bond | 187.241 kg/cm² | 149.034 kg/cm² | 169.945 kg/cm² |
| Strength | | | |

*, **Samples are obtained from market with brand name.

The final product of the orthodontic bracket (39) shows bond strength not lower than that of the other's product though the heat treatment was done lower than 1,000° C.

What is claimed is:

1. A method of adhering composite of ceramic particles to a surface of an orthodontic bracket that has a base portion for attachment to a tooth is comprised of three steps:
preparation of a slurry that is comprised of;
high viscosity mineral oil having viscosity of 150 centipoises at 25° C., and
aluminum hydroxide powder having average particle size of 30 micro meters, and
calcium phosphate hydroxyl powder having an average particle size of 30 micrometers, and
alumina powder that is 10/90 mixture of micrometer powder and nanometer powder; and
pasting the slurry on a tooth contacting surface of an orthodontic bracket with a stainless steel needle of 0.9 mm thickness; and
heating the slurry pasted orthodontic bracket in an electric furnace by
starting from 120° C. and heating rate at a of 1° C./min for 3 hours until it reaches 300° C., and
staying at 300° C. for 30 min, and
heating at a rate of 5° C./min for 138 minutes until it reaches 990° C., and
staying at 990° C. for 30 minutesis, and
cooling the furnace temperature at a cooling rate of 3° C./min for 3 hours and 50 minutes until it reaches 300° C., and
cooling the furnace temperature at a cooling rate 3.6° C./min for 3 hours.

2. A method of adhering composite of ceramic particles to a surface of an orthodontic bracket that has a base portion for attachment to a tooth of claim 1, wherein the preparing step of a slurry and pasting step are executed under nitrogen atmosphere in a glove-box.

3. A method of adhering composite of ceramic particles to a surface of an orthodontic bracket that has a base portion for attachment to a tooth of claim 1, wherein the volume ratio of aluminum hydroxide powder, alumina powder, calcium phosphate hydroxide powder, and high viscosity mineral oil in the slurry is 1:1:1:1.

4. A method of adhering composite of ceramic particles to a surface of an orthodontic bracket that has a base portion for attachment to a tooth of claim 1, wherein maximum temperature of the electric furnace is in a range of higher than 800° C. and lower than 1,000° C.
